(19) United States
(12) Patent Application Publication
(10) Pub. No.: US 2026/0107260 A1
(43) Pub. Date: Apr. 16, 2026

(54) LTE PUBLIC NETWORK REDUNDANT SYSTEM IN MOVING-BLOCK TRAIN CONTROL SYSTEM AND COMMUNICATION METHOD

(71) Applicant: CASCO SIGNAL LTD., Shanghai (CN)

(72) Inventors: Jianyu ZHANG, Shanghai (CN); Yazhong ZHANG, Shanghai (CN); Guoen OU, Shanghai (CN); Wen YANG, Shanghai (CN); Hongfei AN, Shanghai (CN); Ziwei LI, Shanghai (CN); Hao DENG, Shanghai (CN); Wei JIAO, Shanghai (CN)

(73) Assignee: CASCO SIGNAL LTD., Shanghai (CN)

(21) Appl. No.: 19/116,331

(22) PCT Filed: Nov. 17, 2023
(86) PCT No.: PCT/CN2023/132164

§ 371 Date: Mar. 27, 2025

(30) Foreign Application Priority Data
Dec. 29, 2022 (CN) 202211711232.9

(51) Int. Cl. H04W 72/04; H04W 84/00

(52) U.S. Cl. CPC H04W 72/04; H04W 84/005

(57) ABSTRACT

The present invention relates to an LTE public network redundant system in a moving-block train control system and a communication method. The system is used for realizing communication connection between a vehicle-mounted device and a trackside device, characterized in that the LTE public network redundant system comprises a first radio station, a second radio station, a first antenna and a second wire, wherein the vehicle-mounted device is connected to the first radio station and the second radio station at the same time, the first radio station is connected to both the first antenna and the second wire; and the second radio station is connected to both the first antenna and the second wire, so that four IP channels are constructed. Compared with the prior art, the present invention has the advantages of ensuring the redundancy and security of wireless communication, etc.

### TECHNICAL FIELD

The present invention relates to a train signal control system, and in particular to an LTE public network redundancy system in a moving block train control system and a communication method.

### BACKGROUND

With the rapid development and promotion of the railway technology in China, the development of a train control technology has focused on application of satellite positioning, moving block, and the like, to enhance a railway transport capacity, service quality, and train control system performance, while reducing lifecycle costs by using the latest technologies and innovative methods. The moving block train control system is an intelligent train control system that comprehensively uses, based on the research and development achievements of existing train control systems, technologies such as multi-source fusion train autonomous positioning integrating with Beidou satellite navigation, moving block, electronic maps, integrity monitoring, and IP-based (4G) wireless communication, to achieve efficient system operation, simplified trackside equipment, and centralized indoor equipment, meeting the requirements of moving block operation.

With the continuous development of the moving block train control system, especially to enable technologies like train-to-train communication, train-to-train tracking, autonomous driving, and the like, higher requirements have been placed on wireless communication transmission rates, channel capacity, and transmission performance. However, an existing GSM-R wireless communication technology used in a high-speed rail train control system is gradually showing deficiencies in areas such as handover between regions, cell capacity, and system delay. It is worth noting that an LTE wireless communication technology offers advantages such as a high data rate, packet switching, reduced latency, wide-area coverage, and downward compatibility, and has also become highly mature in a public mobile communication field and various industry applications, with complete technical standards and a well-established industry chain. It is worth noting that the GSM-R network is a redundant network, while an LTE public network lacks redundancy. Therefore, there is still a challenge in practical application to a train control system. Therefore, a direction for the development of railway wireless signaling is how to use the LTE technology to construct a redundant broadband mobile communication platform that can support train-ground wireless communication, safety tail-end signaling, and other safety services.

The application of the LTE public network in the train control system still faces the following issues.
1. The LTE network lacks redundancy, which makes it unsuitable for meeting SIL4-level safety requirements in a national railway train control system.
2. A single-standard public network experiences uneven coverage in terms of cells and base stations, and network instability occurs when crossing cell boundaries.
3. The public network is influenced by usage patterns of other users, resulting in uneven distribution of bandwidth efficiency over time.

### SUMMARY

The present invention provides an LTE public network redundancy system in a moving block train control system and a communication method, to overcome defects in the prior art.

The purpose of the present invention can be realized by the following technical solutions:

According to a first aspect of the present invention, an LTE public network redundancy system in a moving block train control system is provided, configured to implement a communication connection between onboard equipment and trackside equipment, where the LTE public network redundancy system includes a first radio, a second radio, a first antenna, and a second wire, the onboard equipment is connected to the first radio and the second radio separately and simultaneously, the first radio is connected to the first antenna and the second wire separately, and the second radio is connected to the first antenna and the second wire separately, to construct four IP channels.

In a preferred technical solution, the first radio and the second radio are radios of different suppliers.

In a preferred technical solution, the first radio and the second radio are respectively connected to different operator networks.

In a preferred technical solution, the onboard equipment has a dual-machine hot standby redundancy structure, and includes onboard equipment A and onboard equipment B separately.

In a preferred technical solution, the trackside equipment has a dual-machine hot standby redundancy structure, and includes trackside equipment A and trackside equipment B separately.

In a preferred technical solution, a red network of an onboard equipment A system is connected to a red network of a trackside equipment A system, a blue network of the onboard equipment A system is connected to a blue network of a trackside equipment B system, a red network of an onboard equipment B system is connected to a red network of the trackside equipment B system, and a blue network of the onboard equipment B system is connected to a blue network of the trackside equipment A system, to implement LTE redundancy connection.

In a preferred technical solution, four IP-based TCP connections are established between the onboard equipment and the trackside equipment simultaneously.

In a preferred technical solution, Subset037 and a national cryptography algorithm SM4 are used for a connection between the onboard equipment and the trackside equipment, to ensure the safety of wireless communication.

According to a second aspect of the present invention, a communication method for the LTE public network redundancy system in a moving block train control system is provided, including the following steps:
when wireless communication equipment works normally, the onboard equipment and the trackside equipment simultaneously use four channels to send data, and the onboard equipment and the trackside equipment perform redundancy filtering on the sent data, to implement efficient train-ground wireless communication.

In a preferred technical solution, in case of a single radio failure or a single operator network failure, two-way connections are maintained respectively between the onboard equipment A and B systems and the trackside equipment A and B systems through a normal working radio, and the onboard equipment and the trackside equipment perform redundancy filtering on sent data.

In a preferred technical solution, in case of a single antenna failure, two radios are capable of interacting with the trackside equipment normally and simultaneously through one antenna, and four wireless connection channels between the train and the ground are not affected.

In a preferred technical solution, in case of both a single antenna failure and a single radio failure, the onboard equipment A and B systems still respectively have a single channel to communicate with the trackside equipment.

In a preferred technical solution, in case of double radio failures or double antenna failures, the wireless communication is interrupted, but based on a fact that a mean time between failures (MTBF) of a radio and a mean time between failures (MTBF) of an LTE combined antenna are both ≥1.00E +05, and a random safety function failure rate is capable of meeting requirements of SIL4.

According a third technical aspect of the present invention, an electronic device is provided, including a memory and a processor, where a computer program is stored in the memory, and when the processor executes the program, the above method is implemented.

According to a fourth aspect of the present invention, a computer-readable storage medium that stores a computer program is provided, and when the program is executed by a processor, the above method is implemented.

Compared with the conventional technologies, the present invention has the following advantages:
(1) in the present invention, requirements of hot standby redundancy in the moving block train control system are met, the redundancy of wireless communication links achieves normal train-ground wireless communication in the event of a single system failure or a single channel failure, and each channel is independent of each other, ensuring the safety and stability of a wireless message;
(2) in the present invention, the LTE public network is used in the moving block train control system, achieving the progress of railway application from a GSM-R private network to an LTE public network;
(3) in the present invention, a redundancy solution using the LTE public network wireless communication is implemented, which lays the foundation for train-train communication, train-train tracking, automatic driving, and other technologies based on wireless transmission of the moving block train control system;
(4) in the present invention, in case of a single set of equipment failure, the system can work normally, which meets the high availability requirements of the system for the communication network; and
(5). in the present invention, the LTE public network is used in the train control system, and an existing operator network can be used, reducing network construction costs.

### BRIEF DESCRIPTION OF DRAWINGS

FIG. 1 is an architecture diagram of an LTE public network redundancy system according to the present invention; and

FIG. 2 is a schematic diagram of train-ground wireless connection according to the present invention.

### DESCRIPTION OF THE EMBODIMENTS

The following is a clear and complete description of technical solutions in embodiments of the present invention in combination with drawings attached to the embodiments of the present invention. Obviously, the embodiments described are a part of the embodiments of the present invention, but not the whole embodiments. Based on the embodiments in the present invention, all other embodiments obtained by those of ordinary skill in the art without creative labor shall fall within the scope of protection of the present invention.

An LTE public network redundancy solution in the moving block train control system is provided in the present invention, to meet a demand for safe train control in the moving block train control system. To meet a SIL4 train control system, the present invention provides the LTE public network redundancy solution. In the present invention, based on the TCP/IP protocol, four safe links are established between a train and the ground, a Subset037 communication protocol is used for the links, a national cryptography algorithm SM4 is used for message verification, the four links are used for data transmission and reception simultaneously, and onboard equipment and ground equipment process data in four channels simultaneously, to ensure the redundancy and security of wireless communication. In the present invention, requirements of hot standby redundancy in the moving block train control system are met, the redundancy of wireless communication links achieves normal train-ground wireless communication in the event of a single system failure or a single channel failure, and each channel is independent of each other, ensuring the safety and stability of a wireless message.

The above solution has the following characteristics:
1. in the present invention, two different operators are selected, problems of uneven spatial distribution of network signal coverage and unstable communication during cell switching are resolved based on different network standards, and the redundancy of the network is ensured;
2. in the present invention, two sets of antennas and radios are used to ensure the redundancy of antennas and radios, and to prevent a failure of a whole system due to a failure of a single antenna or a failure of a single radio;
3. in the present invention, an LTE public network is used, and an existing operator can be used, to resolve a problem of great costs for private network construction; and
4. the onboard equipment and ground equipment in the moving block train control system can support four safe link communications simultaneously to ensure the safety of the wireless communication.

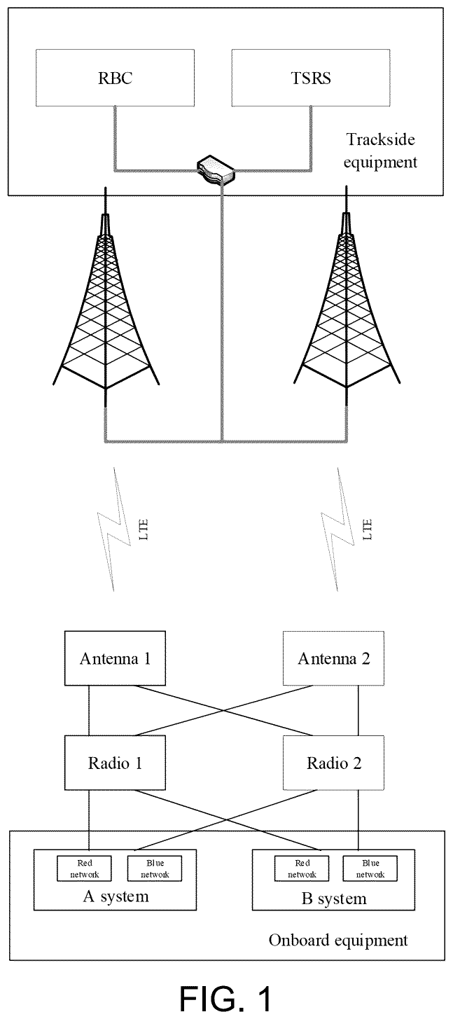

FIG. 1 is an architecture diagram of the LTE public network redundancy solution, in which two radios and two antennas are used to construct the LTE public network redundancy solution. The onboard equipment is connected to the two radios simultaneously, with a total of four IP channels. The two radios are of different suppliers, each radio is connected to the two antennas, and each antenna is connected to the two radios.

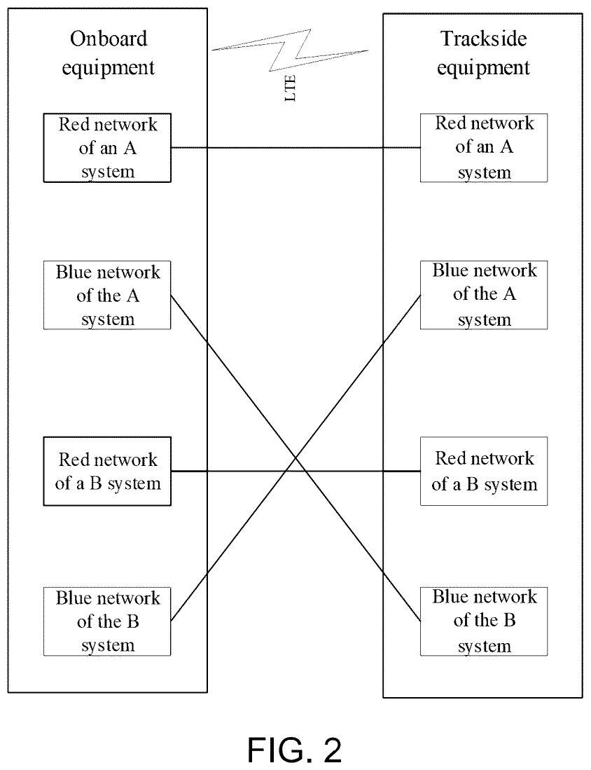

FIG. 2 is a schematic diagram of train-ground wireless connection. A red network of an onboard equipment A system is connected to a red network of a trackside equipment A system, a blue network of the onboard equipment A system is connected to a blue network of a trackside equipment B system, a red network of an onboard equipment B system is connected to a red network of the trackside equipment B system, and a blue network of the onboard equipment B system is connected to a blue network of the trackside equipment A system, to implement LTE redundancy connection.

In the solution, the onboard equipment and the trackside equipment establish four IP-based TCP connections simultaneously, the Subset037 and the national cryptography algorithm SM4 are used for the connections to ensure the security of wireless communication, and the redundancy of the wireless connection of the whole system is achieved through the redundancy between the four channels.

When wireless communication equipment works normally, the onboard equipment and the trackside equipment simultaneously use four channels to send data, and the onboard equipment and the trackside equipment perform redundancy filtering on the sent data, to implement efficient train-ground wireless communication. In actual scenario application, train-ground information interaction is completed within one second.

In case of a single radio failure, two-way connections are maintained between the onboard equipment A/B system and the trackside equipment A/B system through a normal working radio, and the onboard equipment and the trackside equipment perform redundancy filtering on sent data, to implement the efficient train-ground wireless communication.

In case of a single antenna failure, the two radios can interact with the trackside equipment normally and simultaneously through one antenna, and the four wireless connection channels between the train and the ground are not affected, ensuring the redundancy of the system.

In case of both a single antenna failure and a single radio failure, the onboard equipment A/B system still has a single channel to communicate with the trackside equipment, and the wireless communication still has redundancy, which greatly improves the availability of the system.

In case of double radio failures or double antenna failures, the wireless communication is interrupted, but a mean time between failures (MTBF) of a radio and a mean time between failures (MTBF) of an LTE combined antenna are both>1.00E+05, and a random safety function failure rate can meet requirements of SIL4.

In the above technical solution, a problem of application of the LTE public network to moving block train control can be resolved well, and problems of an unstable public network and great costs for private network construction can be resolved. In addition, the solution can meet the SIL4 security requirements of the train control system, and has a practical application value. It is worth noting that the LTE public network can reduce communication delay between a train and the ground or between a train and a train, and increase a channel capacity, so that the trackside equipment can obtain a train location, section occupation, and other information in real time, and real-time status information of each train can be updated timely. Such technology can effectively improve section operation efficiency. Especially, in respect of autonomous driving, train autonomous driving mainly relies on stable interaction of wireless communication and obtains driving permission through wireless information, so that the train automatic driving is completed.

The above is an introduction to embodiments of the method, and the solutions of the present invention are further explained by embodiments of an electronic device and a storage medium.

The electronic device of the present invention includes a central processing unit (CPU) that can execute various appropriate actions and processes according to the computer program instructions stored in a read-only memory (ROM) or loaded from a storage unit into a random access memory (RAM). In the RAM, various programs and data required for the operation of the device can also be stored. The CPU, the ROM, and the RAM are connected to each other via a bus. An input/output (I/O) interface is also connected to the bus.

A plurality of components in the device are connected to the I/O interface, including: input units, such as a keyboard and a mouse; output units, such as various types of displays and speakers; storage units, such as a disk and an optical disc; and communication units, such as a network card, a modem and a wireless communication transceiver. The communication unit allows the device to exchange information/data with other devices through a computer network such as the Internet and/or various telecommunication networks.

The processing unit performs each of the methods and processes described above, such as the methods of the present invention. For example, in some embodiments, the method in the present invention may be implemented as computer software programs that are tangibly included in a machine-readable medium, such as a storage unit. In some embodiments, some or all of the computer programs may be loaded and/or installed onto the device via the ROM and/or communication unit. When the computer programs are loaded into the RAM and executed by the CPU, one or more of the steps of the method in the present invention described above can be performed. Alternatively, in other embodiments, the CPU may be configured to perform the method in the present invention in any other proper manner (for example, with the help of firmware).

Functions described above in the specification can be performed, at least in part, by one or more hardware logic components. For example, hardware logic components that can be used as examples include, unlimitedly, a field-programmable gate array (FPGA), an application-specific integrated circuit (ASIC), an application-specific standard product (ASSP), a system-on-chip (SOC), a complex programmable logic device (CPLD), and the like.

Program code for implementing the method in the present invention may be written in any combination of one or more programming languages. The program code may be provided to processors or controllers of general-purpose computers, specialized computers, or other programmable data processing devices, so that when the program code is executed by the processors or controllers, functions/operations specified in flowcharts and/or block diagrams are implemented. The program code can be executed entirely on a machine, partially on the machine, partially on the machine and partially on a remote machine as a separate software package, or entirely on the remote machine or server.

In the context of the present invention, a machine-readable medium may be a tangible medium that may contain or store programs for use by or in combination with an instruction execution system, apparatus, or device. The machine-readable medium may be either a readable signal medium or machine-readable storage medium. The machine-readable medium may include, but is not limited to, an electronic, magnetic, optical, electromagnetic, infrared, or semiconductor system, apparatus, or device, or any proper combination thereof. A more specific example of the machine-readable storage medium includes an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any proper combination thereof.

The foregoing descriptions are merely implementations of the present invention, but are not intended to limit the protection scope of the present invention. Any equivalent variation or replacement readily figured out by a person skilled in the art within the technical scope disclosed in the present invention shall fall within the protection scope of the present invention. Therefore, the protection scope of the present invention shall be subject to the protection scope of the claims.

1. A LTE public network redundancy system in a moving block train control system, configured to implement a communication connection between an onboard equipment and a trackside equipment, wherein the LTE public network redundancy system comprises a first radio, a second radio, a first antenna, and a second wire, the onboard equipment is connected to the first radio and the second radio separately and simultaneously, the first radio is connected to the first antenna and the second wire separately, and the second radio is connected to the first antenna and the second wire separately, to construct four IP channels.

2. The LTE public network redundancy system in a moving block train control system according to claim 1, wherein the first radio and the second radio are radios of different suppliers.

3. The LTE public network redundancy system in a moving block train control system according to claim 1, wherein the first radio and the second radio are respectively connected to different operator networks.

4. The LTE public network redundancy system in a moving block train control system according to claim 1, wherein the onboard equipment has a dual-machine hot standby redundancy structure, and comprises an onboard equipment A and an onboard equipment B separately.

5. The LTE public network redundancy system in a moving block train control system according to claim 3, wherein the trackside equipment has a dual-machine hot standby redundancy structure, and comprises a trackside equipment A and a trackside equipment B separately.

6. The LTE public network redundancy system in a moving block train control system according to claim 4, wherein a red network of an onboard equipment A system is connected to a red network of a trackside equipment A system, a blue network of the onboard equipment A system is connected to a blue network of a trackside equipment B system, a red network of an onboard equipment B system is connected to a red network of the trackside equipment B system, and a blue network of the onboard equipment B system is connected to a blue network of the trackside equipment A system, to implement a LTE redundancy connection.

7. The LTE public network redundancy system in a moving block train control system according to claim 1, wherein four IP-based TCP connections are established between the onboard equipment and the trackside equipment simultaneously.

8. The LTE public network redundancy system in a moving block train control system according to claim 1, wherein Subset037 and a national cryptography algorithm SM4 are used for a connection between the onboard equipment and the trackside equipment, to ensure safety of wireless communication.

9. A communication method for the LTE public network redundancy system in a moving block train control system according to claim 1, wherein comprising the following steps:
when a wireless communication equipment works normally, the onboard equipment and the trackside equipment simultaneously use four channels to send data, and the onboard equipment and the trackside equipment perform redundancy filtering on sent data, to implement efficient train-ground wireless communication.

10. The communication method according to claim 8, wherein in case of a single radio failure or a single operator network failure, two-way connections are maintained respectively between the onboard equipment A and B systems and the trackside equipment A and B systems through a normal working radio, and the onboard equipment and the trackside equipment perform redundancy filtering on sent data.

11. The communication method according to claim 8, wherein in case of a single antenna failure, two radios are capable of interacting with the trackside equipment normally and simultaneously through one antenna, and four wireless connection channels between train and ground are not affected.

12. The communication method according to claim 8, wherein in case of both a single antenna failure and a single radio failure, the onboard equipment A and B systems still respectively have a single channel to communicate with the trackside equipment.

13. The communication method according to claim 8, wherein in case of double radio failures or double antenna failures, the wireless communication is interrupted, but based on a fact that a mean time between failures (MTBF) of a radio and a mean time between failures (MTBF) of a LTE combined antenna are both≥1.00E+05, a random safety function failure rate is capable of meeting requirements of SIL4.

14. An electronic device, comprising a memory and a processor, a computer program is stored in the memory, wherein when the processor executes the program, the method according to claim 9 is implemented.

15. A computer-readable storage medium, storing a computer program thereon, wherein when the program is executed by a processor, the method according to claim 9 is implemented.

16. An electronic device, comprising a memory and a processor, a computer program is stored in the memory, wherein when the processor executes the program, the method according to claim 10 is implemented.

17. An electronic device, comprising a memory and a processor, a computer program is stored in the memory, wherein when the processor executes the program, the method according to claim 11 is implemented.

18. An electronic device, comprising a memory and a processor, a computer program is stored in the memory, wherein when the processor executes the program, the method according to claim 12 is implemented.

19. An electronic device, comprising a memory and a processor, a computer program is stored in the memory, wherein when the processor executes the program, the method according to claim 13 is implemented.
